(19) United States
(12) Patent Application Publication
(10) Pub. No.: US 2015/0156746 A1
(43) Pub. Date: Jun. 4, 2015

(54) METHOD AND SYSTEM TO ESTIMATE THE LOCATION OF A RECEIVING DEVICE

(71) Applicant: RED POINT POSITIONING CORPORATION, Brookline, MA (US)

(72) Inventors: Jonathan Horne, Boulder, CO (US); Georgiy Pekhteryev, Kharkiv (UA)

(21) Appl. No.: 14/559,524

(22) Filed: Dec. 3, 2014

Related U.S. Application Data
(60) Provisional application No. 61/911,188, filed on Dec. 3, 2013.

(51) Int. Cl. H04W 64/00; G01S 5/14

(52) U.S. Cl. CPC H04W 64/00; G01S 5/14

(57) ABSTRACT

A system for estimating the location of a mobile device is discussed herein. In one embodiment, the system can include a mobile device having a processor and a receiver, and a network of transceiver devices. The transceiver devices can be paired into multiple transceiver pairs of transceiver devices within communication range. The mobile device and transceivers can transmit a range request (REQ) packet by one transceiver in a pair; receive the REQ packet by another transceiver in the pair; transmit a range response (RSP) packet by the another transceiver; receive REQ packets by the mobile device; and receive RSP packets by the mobile device. The system is configured to estimate the differences of distances from the mobile node to the first and the second transceiver node in pairs; and to determine a location of the mobile device based on the estimated distance differences of devices.

### CROSS-REFERENCE TO RELATED APPLICATIONS

This application claims priory under 35 U.S.C. §119(e) to U.S. Provisional Patent Application No. 61/911,188, the entirety of which is incorporated by reference herein.

### FIELD OF THE INVENTION

This invention relates generally to localization systems, and more particularly to methods and systems to locating objects wirelessly using time-of-flight information.

### BACKGROUND OF THE INVENTION

In many applications, it is desirable or even necessary to estimate the location of an object with a high accuracy. There are many systems that are designed to allow a device to carry out location estimation using radio frequency (RF) signals. E.g., a device can estimate its location using signal strength of received RF signals, such as the method described in U.S. Pat. No. 7,515,578. The angle of arrival of the received signal can also be used for determining the location of the receiver.

The time of flight (TOF), also known as time of arrival (TOA), can also be used for location estimation. In an example shown in FIG. 1, the TOA based location estimation is typically carried out using trilateration, i.e., the location of an object is estimated based on the distances between the object to be estimated and some objects with their position known. Typically, because the target device is not synchronized to the anchor devices, the time of flight needs to be estimated using a round-trip flight time. For example, a first device transmits a first ranging signal first; then, after receiving the first ranging signal, the second device transmits a second ranging signal. The round trip delay is estimated by the first device. Such a technique is often referred to as Two-Way TOA (TW-TOA) and is commonly used in many systems. Unfortunately, TW-TOA requires a large number of transmissions among all nodes and as a results, a TW-TOA based system cannot accommodate many mobile devices. The large number of devices also results in higher power consumption of the nodes.

Alternatively location estimate can be performed using time difference of flight (TDoF), also known as time difference of arrival (TDOA). In an example shown in FIG. 2, a mobile node 102 broadcasts a radio signal and the signal is received by the receivers of all anchor nodes 101 within its range. If we denote the arrival time of the signal to anchor node i and j as ti and tj respectively, the time difference of the arrival time Δtᵢⱼ=tⱼ−tᵢ is recorded, instead of the absolute time ti and tj.

The TDOA described above has a significant advantage over TOA, because it only requires the mobile node to transmit once and the anchor nodes only need to receive.

In the system illustrated in FIG. 2, because only the target devices are required to transmit, the system has better efficiency and can admit a larger number of target devices in a single coverage area. However, the target devices are not synchronized and the transmissions may collide. Moreover the anchor nodes need to be synchronized. The synchronization is accomplished by all of the anchor nodes adjusting time to a common reference timing source. Typically, a synchronization unit is used to generate the timing reference signal and distributes it to all anchor nodes via cables. A major drawback of such a system is the complexity and subsequently installation cost. It also suffers performance degradation as the density of target devices increases.

All methods described in the prior art above require a mobile node to transmit, in order to estimate its location using triangulation, trilateration, or other techniques. This significantly limits the total number of mobile nodes that can be localized in a single coverage area. As the number of nodes increases, the probability of collision grows rapidly. A high mobile node density will cause the degradation of the network performance and even cease to function properly altogether.

### SUMMARY OF THE INVENTION

This invention provides systems and methods that allow unlimited number of mobile devices in a coverage area by a set of nodes to be localized. Additionally, all mobile devices are capable of localizing itself without transmitting radio signals.

The embodiments of the invention provide a method for estimating a time difference of arrival and subsequently estimating the location of a receiving device. A set of anchor nodes transmit ranging packets in specific sequences and a mobile receiver estimates the time difference of arrival between different paths. A location estimate based on time-difference-of-arrival (TDoA) is performed to obtain the location of the receiving device.

In one embodiment of the invention, anchors in a system form anchor pairs with neighboring anchor nodes. The anchor pairs transmit ranging packets sequentially. Within each pair, one of the anchor nodes transmits a ‘range request’ (REQ) packet, the other anchor node transmitting a ‘range response’ (RSP) packet upon receiving the REQ packet. A receiving node estimates the TDoA between nodes in anchor pairs and estimates its location using TDoA measurements from multiple pairs.

In another embodiment, anchor nodes also form node pairs and transmit ranging packets sequentially. The first node of an anchor pair transmits a RSP packet and the second node in an anchor pair transmits a ‘range relay’ (RLY) packet, instead of a RSP packet. A RLY packet of one pair is received by one node of a different pair, and it in turn transmits its own RLY packet.

### BRIEF DESCRIPTION OF THE DRAWINGS

FIG. 1 is an illustration of a localization system using two-way TOA scheme.

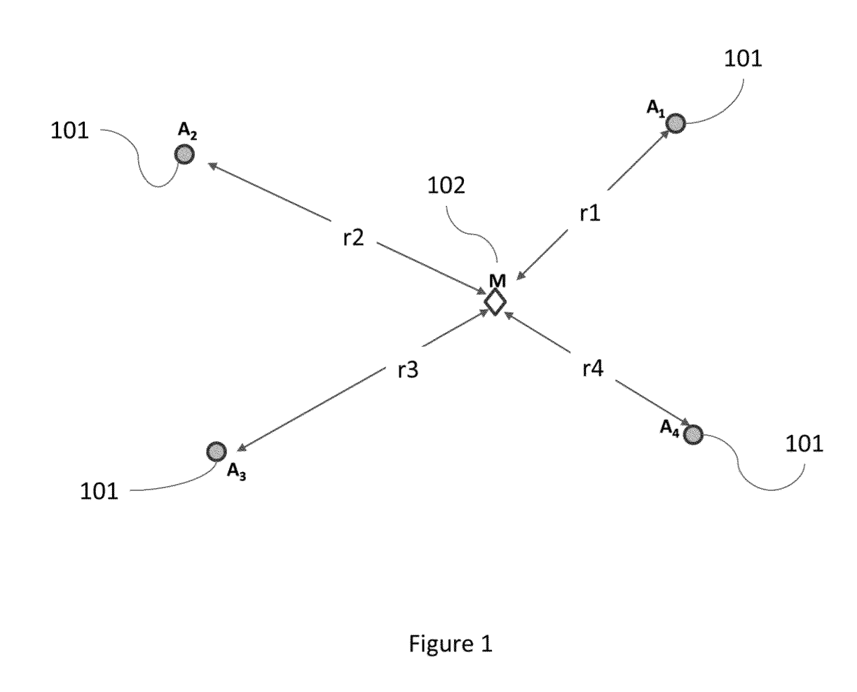

FIG. 2 depicts a TDOA system with synchronization unit.

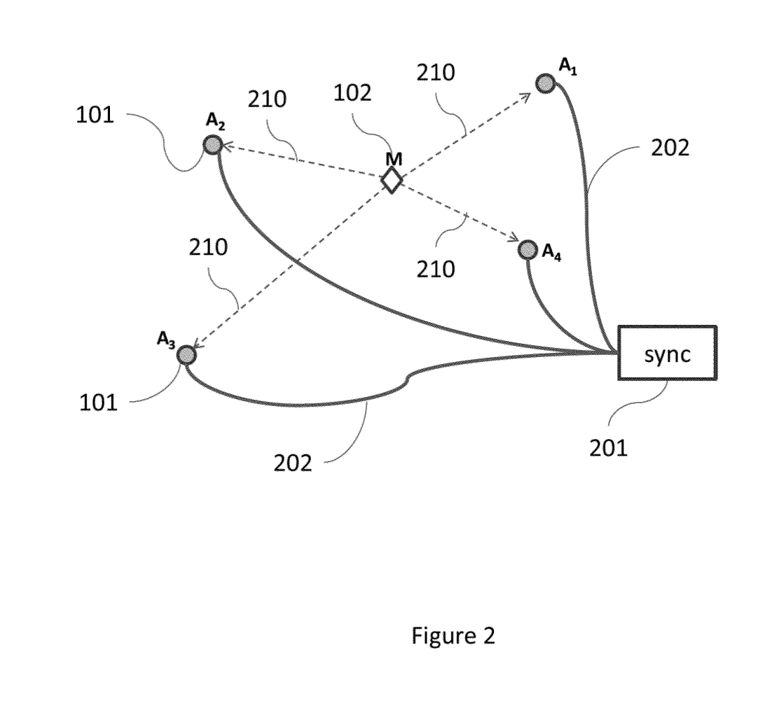

FIG. 3 illustrates the principle of time difference of arrival position estimation.

FIG. 4 depicts one embodiment of the invented mobile receiving only TDOA localization method.

FIG. 5 illustrates a paired transmission schedule for the invented TDOA localization.

FIG. 6 illustrates a daisy-chained transmission schedule for TDOA localization.

### DETAILED DESCRIPTION OF THE EMBODIMENTS

In a wireless network of multiple anchor nodes, one of the anchor nodes, denoted as the initiator, transmits a REQ packet. The REQ packet is received by a number of anchor nodes in the initiator's range. Some or all of these nodes transmit in response to the reception of the REQ packet, a second packet, denoted as RSP packet.

In this exemplary embodiment, we limit the localization in a two dimensional space, i.e., we assume all devices are located at the same height. It is rather straightforward to extend the design to three dimensions.

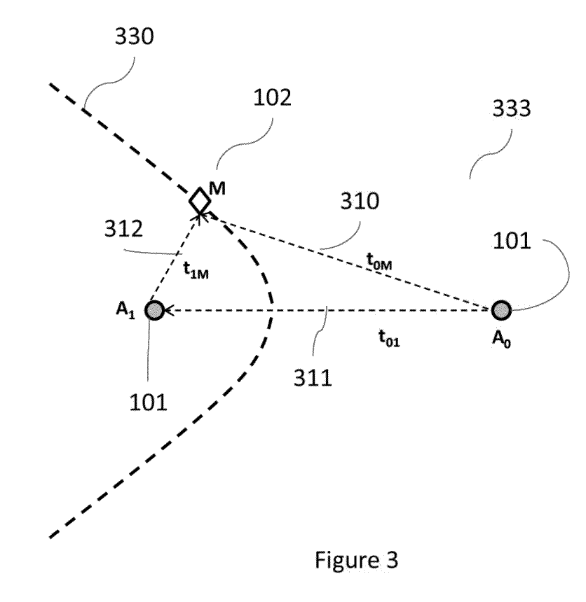

With reference to FIG. 3, we denote the distance between a fixed device Ai 101 (i.e., a device which location is known) and a target device 102 (i.e., a device which location is unknown, denoted as M) as rᵢₘ. The time of flight (TOF) from Ai to M is tᵢₘ=rᵢₘ/c, where c is the speed of the electromagnetic wave (˜3×10⁸ m/sec). Conversely, we can compute the distance from the time of flight as rᵢₘ=tᵢₘ*c.

FIG. 3 illustrates the basic principle of localization using TDoA. Let the distance between nodes be d01, d0M, d1M respectively and the corresponding flight times be t₀₁ 311, t_{0M} 310, t_{1M} 312. Mobile device M 102 can determine the time difference of flight for two different paths—one path being A₀ to A₁ to M, and the other being A₀ to M.

Because it takes time for anchor node A₁to receive a REQ packet and then transmit a RSP packet, this turnaround time can be used in the calculation for the time of flight for the path A₀ to A₁ to M. The first anchor node in the node pair, A₀, transmits to a second anchor node in the pair A₁ a range request packet REQ1. The anchor node A₁, after receiving REQ1, transmits a RSP1 packet after a turnaround time T^{a}₁. T^{a}₁ is defined as the time elapsed from the reception of REQi packet to the start of transmitting RSP1 packet at A₁. The value of T^{a}₁ can be a predefined and known to the receiving device. In such a case, it is not necessary to transmit it. In the case T^{a}₁ is unknown to the receiving mobile device, its value can be embedded in the RSP1 packet, or sent to the receiving mobile device in a separate packet.

With the turnaround time known, mobile device M can determine the time difference of flight for the two paths based on the arrival times of the two different signals and the turnaround time. With this time difference of flight Δt_{01,M}=t₀₁+t_{1M}−t₎ₘ determined by the mobile device, we can find that the mobile device is located on a hyperbolic curve 330.

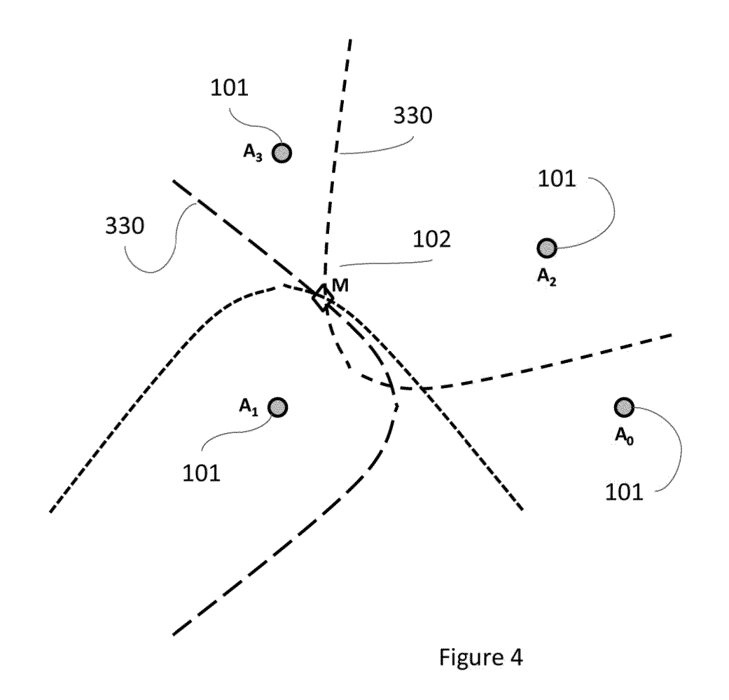

If there are more than 3 anchor pairs and the TDoAs are known, the location of the mobile node can be determined by finding the intersections of all the hyperbolic curves, as shown in FIG. 4. Generally, however, the measurements of time difference contain noise and algorithms such as maximum likelihood, least squared, weighted least squared and etc. can be used to estimate the mobile node locations.

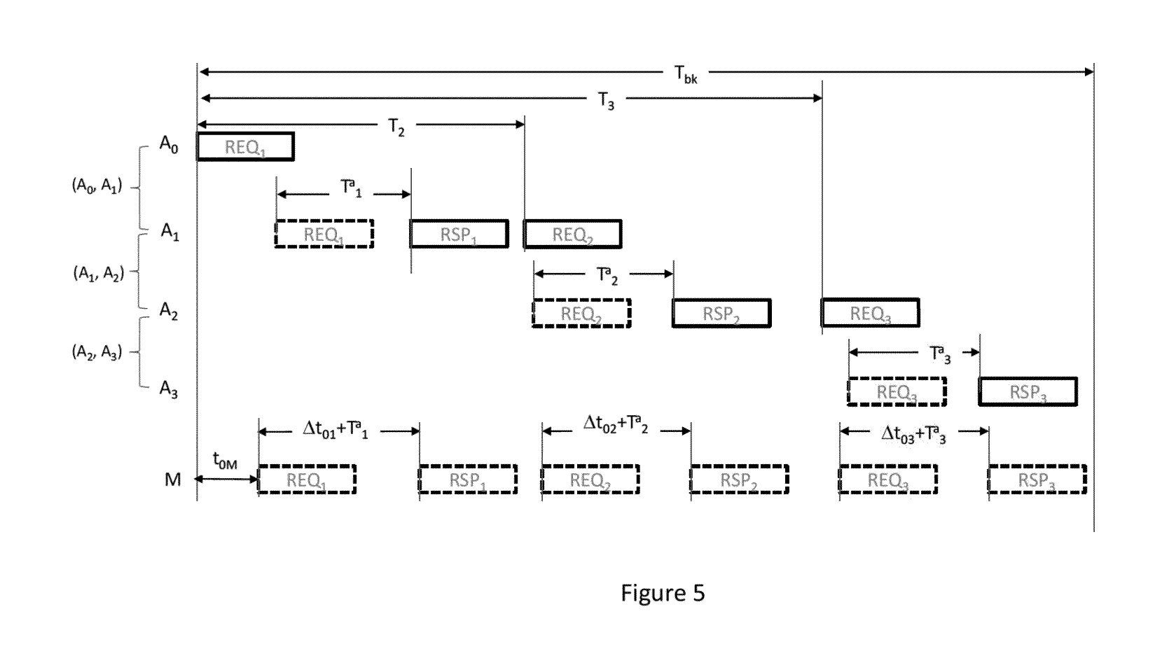

In the example illustrated in FIG. 4, we assume (A₀, A₁), (A₁, A₂) and (A₂, A₃) are anchor pairs. In the event that the system creates redundant pairs, i.e. (A₁, A₀) and (A₀, A₁), the system can be programmed to trim down the redundant pair such that only one is used to calculate the position. FIG. 5 illustrates one embodiment of such a system and method, though a person of ordinary skill will recognize that there are additional ways to pair the anchor nodes within the spirit of the invention. Moreover, it may be advantageous to randomize or deterministically schedule the transmission of the REQ and RSP packets to avoid collision.

As shown in FIG. 5, after the first pair (A₀, A₁) complete the transmissions, the other pairs (A₁, A₂) and (A₂, A₃) also transmit REQᵢ and RSPᵢ packets in a similar fashion.

The receiving mobile device M 102 receives all or some of the REQi and RSPi packets. It estimates the time differences of arrival between the first anchor device A, and other neighboring anchors Aⱼ using

Δt_{ij,M}=t′ⱼ−t′ᵢ−T′^{a}ⱼ

where t′ᵢ and t′ⱼ are the time of arrival of RSPᵢ and REQᵢ packets at the receiving mobile node, T′^{a}ⱼ is the estimated turnaround time at node Aⱼ.

A turnaround time T^{a}ⱼ is estimated by the second anchor node in the pair Aⱼ. In the presence of clock frequency offset, and assuming the frequency offset is small, the estimated turnaround time T′^{a}ⱼ is derived as

T′^{a}ⱼ=T^{a}ⱼ (1−εᵢₘ)

εⱼₘ=Δfⱼₘ/f=(fⱼ−fₘ)/f,

Where εⱼₘ is the relative frequency offset between the anchor node Aⱼ and the mobile node M. Δfⱼₘ is the absolute clock frequency offset, and f is the nominal frequency.

The mobile node position can be estimated when all, or a sufficient number of Δt_{ij,M} are computed. Preferably, the number of Δt_{ij,M} is one more than the number of degrees of freedom. Therefore, to locate the mobile node M within an X, Y plane at least 3 Δt_{ij,M} are preferred and at least 4 Δt_{ij,M} are preferred to locate mobile node M in 3D space. The position estimate can be carried out by the mobile node or by a position solver external to the mobile device. In the case an external position solver is used, the values of Δt_{ij,M} can be sent by the mobile node to the network.

Alternatively, the mobile device can estimate its location and then transmit the estimated location back to the network.

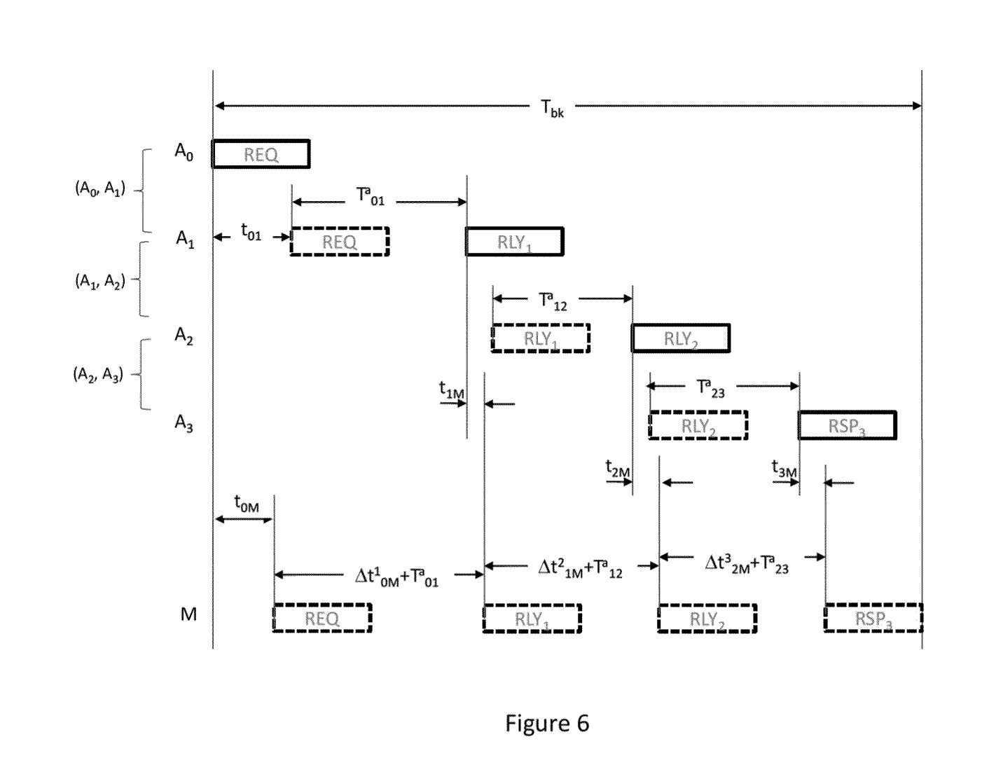

FIG. 6 shows another embodiment of invented method, showing a daisy chained transmission schedule, which reduces the number of transmissions. Again, assuming (A₀, A₁), (A₁, A₂) and (A₂, A₃) are anchor pairs formed in a network. Anchor device A₀ transmit a range request packet REQ₁. The REQ1 is received by node A₁, which responds by transmitting a relay packet RLY₁. The RLY₁ packet also serves as the range request packet for the (A₁, A₂) pair. The anchor node A₂ then responds to RLY₁ by transmitting RLY₂ packets, which similarly, serves as a request packet for the (A₂, A₃) pair. Node A₃ responds to RLY₂ by transmitting RSP₃, or RLY₃ if there are other pairs in the network that include A₃.

The advantage to such an embodiment is an overall increase in network efficiency. Because the RLY₁, RLY₂ and RLYₙ packets (assuming n nodes) serve the duel function of a relay packet and the range request packet for all but the first range request packet REQ₁, the network reduces the duplication of creating and sending superfluous packets. This is advantageous in real life applications where there can be a large number of mobile device nodes seeking localization information from each anchor pair at any given time. Any reduction in network traffic allows for additional mobile device nodes to request localization information.

Similar to the example discussed above with regards to FIG. 5, the mobile device M 102 receives REQᵢ, RLYᵢ and/or RSPᵢ packets, estimates the time differences of arrival between packets from different nodes in the pairs as Δt_{ij,M}=t′ⱼ−t′ᵢ−T^{a}ᵢⱼ and performs location estimate accordingly.

In certain embodiments, the packets above can be transmitted and received using Ultra Wide-Band (UWB) technology employing frequency bandwidth of 500 Mhz or greater. UWB can be effective for short range data communication and can also provide accurate ranging within the systems and methods of the invention. IEEE 802.15.4a provides standards for the use of UWB technology in wireless communications and is incorporated by reference in its entirety herein. While other technologies can be used with the invention, UWB communications can be combined synergistically with the methods and systems of the invention to provide an intelligent, high precision, real-time location service that can handle a large number of moving devices.

Anchor nodes and mobile devices useful with the invention can be constructed using special purpose or commercial off-the-shelf parts. In general, the devices will need to have a processor, a memory storing instructions for the processor and/or data, and a transceiver for transmitting and/or receiving packets. In the case of anchor nodes, these can be installed with building mains power, so size and power usage can be less important than for the mobile device. The mobile device can be configured, for example, as a tag that can be attached to various items for tracking purposes. Accordingly, the tag should be small in size and have an optimized power consumption since the tag will likely be battery powered. In addition, while in some embodiments, the tag may only need to receive signals, it may still employ a transceiver as the receiver on the tag.

One example of a hardware implementation that might be useful with the invention is the STM32W108C8 high-performance IEEE 802.15.4 wireless system-on-chip with flash memory available from STMICROELECTRONICS (www.st.com). This chip includes a processor, memory, transceiver, timer and other circuitry useful in implementing the invention. In other embodiments, in particular, in UWB embodiments, a UWB transceiver such as the DW1000 SENSOR from DECAWAVE, Ltd. (www.decawave.com) can be employed as the transceiver in the mobile device or anchor node. This device can communicate with a processor for instructions and/or data storage. Other commercial or purpose built hardware could also be employed in addition to or in place of such systems.

The invention provides systems and methods for estimating the position of a target using TDOA. A target does not need to transmit any packets. The invention can, therefore, provide advantages over other methods in that an unlimited number of target devices can be accommodated in the same coverage area without increasing the number of transmissions.

Although the invention has been described by way of examples of preferred embodiments, it is to be understood that various adaptations and modifications may be made within the spirit of the scope of the invention. Therefore, it is the object of the appended claims to cover all such variations and modifications as come within the true spirit and scope of the invention.

1. A method for locating a position of a mobile device, in a network of transceiver devices, comprising:
forming transceiver pairs in a network between anchor nodes that are within communication range, each transceiver pair transmitting sequentially ranging packets by:
transmitting, by a first transceiver in the pair, a range request (REQ) packet;
receiving, by a second transceiver device in the pair, the REQ packet;
transmitting, by the second transceiver device, a range response (RSP) packet;
receiving, by the mobile device, REQ packets;
receiving, by the mobile device, RSP packets;
estimating the differences of distances from the mobile node to the first and the second transceiver node in pairs;
determining a location of the mobile device based on the estimated distance differences of devices.

2. The method of claim 1 , where a transceiver pair is formed with a first transceiver device and a second transceiver device.

3. The method of claim 1, where multiple transceiver pairs are formed in the network.

4. The method for claim 1, where the pairs are determined during the formation of the network.

5. The method for claim 1, where a turnaround time is embedded in the RSP packets.

6. The method for claim 1, where a turnaround time is predetermined and not transmitted.

7. The method for claim 1, where the transmission of REQ and RSP packets are randomized to avoid collision.

8. The method for claim 1, where the transmission of REQ and RSP packets are deterministically scheduled to avoid collision.

9. The method of claim 1, where redundant transmit pairs are trimmed.

10. The method of claim 1, where the location of the mobile device is estimated by the mobile device.

11. The method of claim 1, where the location of the mobile device is estimated by an position estimator external to the mobile device.

12. The method of claim 1, where the mobile device transmits its own estimated location to the network.

13. The method of claim 11, where the mobile device transmits the time difference of arrival values to the external position estimator.

14. A method for locating a position of a receiving device, in a network of transceiver devices, comprising:
forming transceiver pairs in a network between anchor nodes that are within communication range, each transceiver pair sequentially transmitting ranging packets including the relaying process:
broadcasting a range request (REQ) packet by a first transceiver device;
receiving, the REQ packet by a second transceiver device;
transmitting, by the second transceiver device, a range relay (RLY) packet after receiving the first REQ packet;
receiving, by a third receiving device, the RLY packet;
continuing, by other transceiver devices the relaying process;
stopping, the relaying process at the stop condition;
estimating a difference of distance from a direct path between the first transceiver device and the receiving device, to an indirect path between the first transceiver device and the receiving device via the second transceiver devices;
determining a location of the receiving device based on the estimated distance differences of devices

15. The method of claim 14, where a relaying sequence is pre-determined by the initiator.

16. The method of claim 14, where the relay sequence is random.

17. A system for estimating the location of a mobile device, comprising:
a mobile device having a processor and a receiver;
at least three transceiver devices forming a network of transceiver devices, each transceiver having a processor and a receiver for sending and receiving communication packets, wherein the transceiver devices are paired into multiple transceiver pairs of transceiver devices within communication range;
wherein the mobile device and transceivers are configured to:
transmit a range request (REQ) packet by a first transceiver in a pair;
receive the REQ packet by a second transceiver device in the pair;
transmit a range response (RSP) packet by the second transceiver device;
receive REQ packets by the mobile device; and
receive RSP packets by the mobile device;
wherein the system is configured to estimate the differences of distances from the mobile node to the first and the second transceiver node in pairs; and
wherein the system is configured to determine a location of the mobile device based on the estimated distance differences of devices.

18. The system of claim 17, where a transceiver pair is formed with a first transceiver device and a second transceiver device.

19. The system of claim 17, where multiple transceiver pairs are formed in the network.

20. The system of claim 17, where the pairs are determined during the formation of the network.

21. The system of claim 17, where a turnaround time is embedded in the RSP packets.

22. The system of claim 17, where a turnaround time is predetermined and not transmitted.

23. The system of claim 17, where the transmission of REQ and RSP packets are randomized to avoid collision.

24. The system of claim 17, where the transmission of REQ and RSP packets are deterministically scheduled to avoid collision.

25. The system of claim 17, where redundant transmit pairs are trimmed.

26. The system of claim 17, where the location of the mobile device is estimated by the mobile device.

27. The system of claim 17, where the location of the mobile device is estimated by an position estimator external to the mobile device.

28. The system of claim 17, where the mobile device transmits its own estimated location to the network.

29. The system of claim 28, where the mobile device transmits the time difference of arrival values to the external position estimator.
